(19) United States
(12) Patent Application Publication
(10) Pub. No.: US 2018/0046466 A1
(43) Pub. Date: Feb. 15, 2018

(54) METHOD AND SYSTEM FOR THE LOADING OF AN OPERATING SYSTEM ON A COMPUTING DEVICE

(71) Applicant: QUANTUM DIGITAL INNOVATIONS, Montréal (CA)

(72) Inventor: Guy BOULIANE, St-Isidore-de-Laprairie (CA)

(21) Appl. No.: 15/552,247

(22) PCT Filed: Feb. 19, 2016
(86) PCT No.: PCT/CA2016/000044

§ 371 Date: Aug. 18, 2017

Related U.S. Application Data
(60) Provisional application No. 62/118,193, filed on Feb. 19, 2015.

(51) Int. Cl. G06F 9/445; G06F 9/44

(52) U.S. Cl. CPC G06F 9/445; G06F 9/4406

(57) ABSTRACT

A method and system for the loading of an operating system on a computing device having a central processing unit and a dedicated operating system graphic processing unit, which provides Image read/write functionality to the central processing unit. The method comprises acquiring an image representation of the operating system, the image being composed of pixels having color values encoding operating system executable code to be executed by the central processing unit, providing the operating system image to the dedicated graphic processing unit and accessing the encoded operating system executable code using the coordinates of the image pixels.

### CROSS-REFERENCE TO RELATED APPLICATIONS

This application claims the benefits of U.S. provisional patent application No. 62/118,193 filed on Feb. 19, 2015, which is herein incorporated by reference.

### TECHNICAL FIELD

The present disclosure relates to a method and system for the loading of an operating system on a computing device.

### BACKGROUND

An operating system (OS) is software that manages computer hardware and software resources and provides common services for computer programs, At boot up the OS is loaded into the computer memory and during use of the computer many read/write processes are executed, each requiring delay as the computer access the storage device on which are stored the OS and related data/applications.

Therefore, there is a need for a system that keeps data available at all times and makes the read/write process faster, more efficient and most of all available at all times as well.

### SUMMARY

It is therefore a general object of the present disclosure to provide a method and system that make it possible to load all OS data from data storage into a 2D or 3D image and allow the real-time management of the entire OS without reprocessing the same processes repeatedly.

Another object of the present disclosure is to provide a method and system that makes the process of loading data from memory fast and available at all time, as well as allowing the extension of available memory space using a 2D or 3D graphic processing unit using the pixel color Information as data bits and the pixel coordinates as memory addresses.

Therefore, according to an aspect of the present disclosure, there is provided a method for the loading of an operating system on a computing device having a central processing unit, the method comprising:
providing a dedicated operating system graphic processing unit in communication with the central processing unit;
acquiring an image representation of the operating system, the image being composed of pixels having color values encoding operating system executable code to be executed by the central processing unit;
providing the operating system image representation to the dedicated graphic processing unit;
accessing the encoded operating system executable code using the coordinates of the image pixels; and
providing the accessed encoded operating system executable code to the central processing unit;
wherein the central processing unit executes the provided accessed encoded operating system executable code.

According to another aspect of the present disclosure, there is provided a system for the loading of an operating system on a computing device having a central processing unit having an associated memory, the system comprising:
a dedicated operating system graphic processing unit in communication with the central processing unit;
a data storage in communication with the central processing unit, the data storage having stored therein an image representation of the operating system, the image being composed of pixels having color values encoding operating system executable code to be executed by the central processing unit;
an operating system boot process stored in the associated memory, the operating system boot process being in the form of executable code to be executed by the central processing unit upon boot up and configuring the central processing unit to:
   provide the operating system image representation stored in the data storage to the dedicated graphic processing unit;
   access the encoded operating system executable code using the coordinates of the image pixels; and
   execute the accessed encoded operating system executable code.

According to another further aspect of the present disclosure, there is provided a method or system for the loading of an operating system on a computing device as described above, wherein the image is either in 2D or 3D.

### BRIEF DESCRIPTION OF THE FIGURES

Embodiments of the disclosure will be described by way of examples only with reference to the accompanying drawings, in which:

FIG. 1 is a schematic view of a computing device having a system for the loading of an operating system (OS) on a computing device in accordance with an Illustrative embodiment of the present disclosure;

FIG. 2 is a schematic representation of an example of how data is stored in an active image in the frame buffer of the system for the loading of an operating system on a computing device;

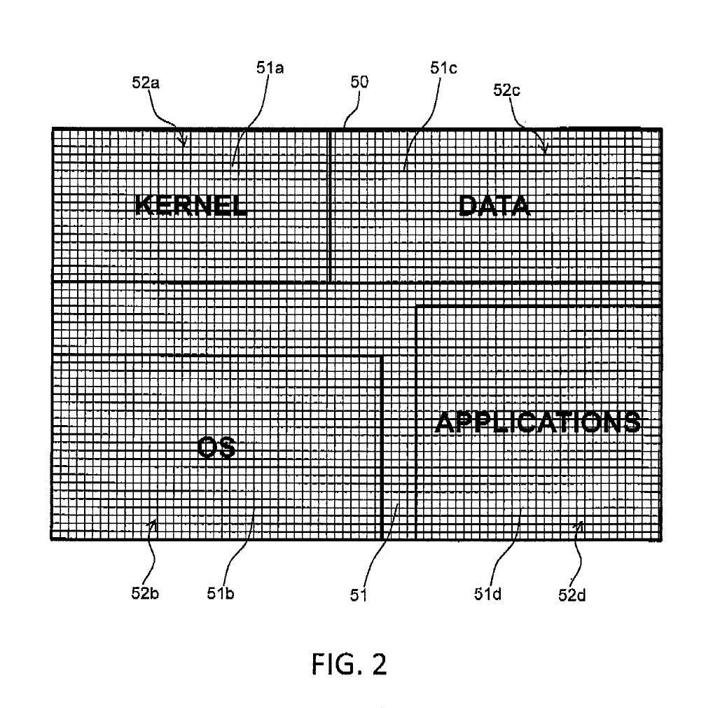

FIG. 3 is a schematic representation of an example of how data is stored In a plurality of images In the frame buffer of the system for the loading of an operating system on a computing device;

FIG. 4 is a schematic view of computing devices connected to an OS loading system on a computing device through a network; and

FIG. 6 is a flow diagram of the OS boot process In accordance with the illustrative embodiment of the present disclosure.

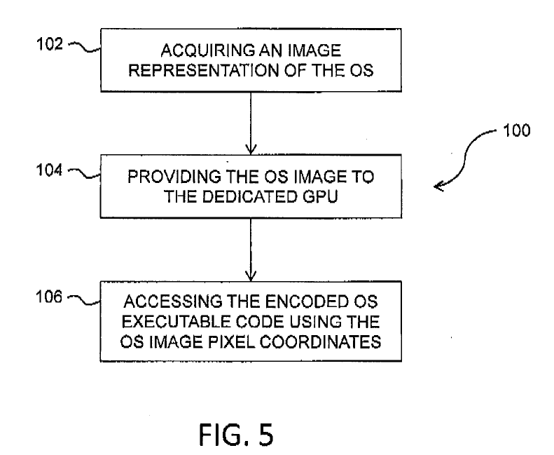

Similar references used in different Figures denote similar components.

### DETAILED DESCRIPTION

Generally stated, the non-limitative illustrative embodiments of the present disclosure provide a system and method for the loading of a computing device operating system (OS), more particularly a system and method for reading an image representation of an operating system from a dedicated graphic processing unit (GPU) to be executed by the central processing unit (CPU) of a computing device. Each pixel includes OS code data to be executed by the CPU and can be individually addressed, the number of OS code bits encoded Into each pixel varies depending on the bits per pixel (BPP) of the GPU, for example a true color GPU has 24-bit (16 million color) pixels while a deep color GPU has 30, 36 or even 48-bit pixels, All CPU calculations are then executed from the currently loaded image from the memory buffer of the dedicated GPU with data found in the image. Addressing for the OS code is performed using the coordinates of the image pixels (i.e. XY coordinates for a 2D image or XYZ coordinates for a 3D image),

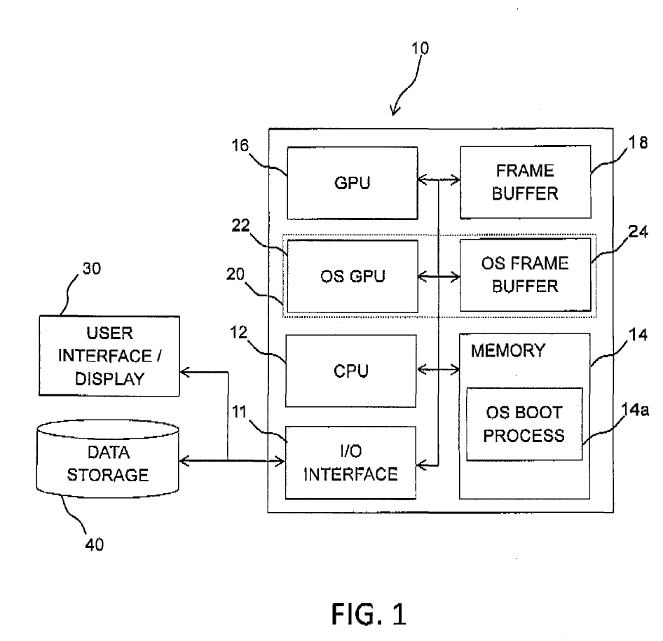

Referring to FIG. 1, there is shown a computing device 10 having an OS loading system 20 in accordance with an illustrative embodiment of the present disclosure. The computing device 10 generally includes a CPU 12 with an associated memory 14 having stored therein processor executable instructions for configuring the CPU 12 to perform the OS boot process 14a, a GPU 16 with an associated frame buffer 18 and the OS loading system 20, The computing device 10 further includes an input/output (I/O) interface 11 for communication with further devices such as, for example, a user interface/display 30 and data storage 40.

The OS loading system 20 includes a dedicated GPU 22 with associated frame buffer 24.

Upon boot up of the computing device 10, the OS boot process 14a is executed by the CPU 12, which loads all OS related data in the form of an image from the data storage 40 (or any other data storage and/or memory, locally or remotely located) onto the OS loading system 20 as an active image in its frame buffer 24.

Referring to FIG, 2, the frame buffer 24 stores the contents of the OS image 50, which can be either 2D or 3D, pixel by pixel 51. The CPU 12 can then access the kernel 52a, OS 52b, related data 52c and applications 52d directly from the frame buffer 24, the data being encoded in respective pixels 51a, 51b, 51c and 51d. Each pixel 51 contains a given number of bits of data, for example 24 bits for true color and 48 bits for deep color. Addressing Is done by the dedicated GPU 22 using the pixels 51 coordinates in the 2D or 3D image 50. Accordingly, the image 50 loaded in the frame buffer 24 of the dedicated GPU 22 becomes the active OS needed to run the computing device 10 similarly to the way L1 or L2 caches are currently used to accelerate the computing process, but even faster because of the computing power of the dedicated GPU 22. This process speeds up the data transfer and the reading of all data stored in the image 50.

At any time, an image file snapshot can be taken of image 50 and saved, for example in the data storage 40, for backup purposes, allowing the computing device 10 to return to that current state at any point in the future. The image 50 can also be used to load multiple OS using compression and decompression.

The virtual address space provided by the pixels 51 coordinates works in a fashion similar to random access memory (RAM) but instead of physical addresses, particular points on the image 50 grid become the address reference to data sequences. The image 50 may also be modified by the dedicated GPU 22 to store data by changing the color of pixels 51 (i.e. bits) similarly to data being stored in RAM,

It is to be understood that the computing device 10 may be provided with multiple CPUs and that the various described procedures may be executed by one or more of the CPUs. It is also to be understood that that various image formats may be used and that in an alternative embodiment a series of image frames or video may be used. Referring to

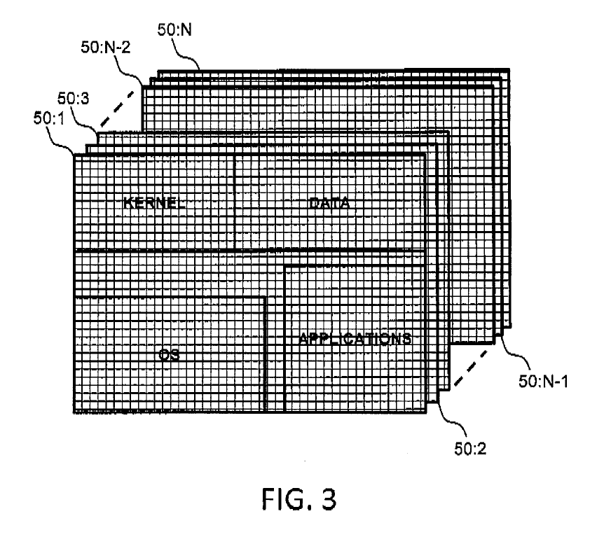

FIG. 3, there is shown an example of N image frames 50:1. 50:2, 50:3-50:N-2, 50:N-1, 50:N used to store the OS image as well as any other additional data and/or provide extra data storage capacity.

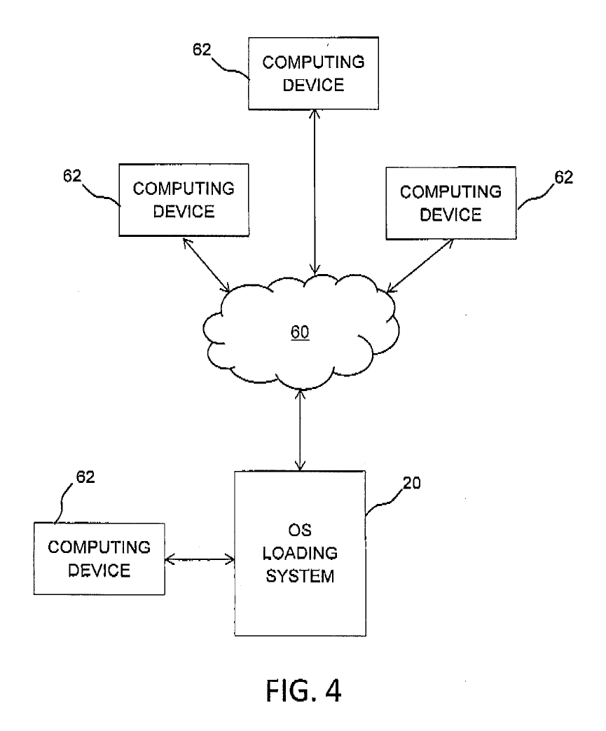

Furthermore, in a further alternative embodiment illustrated in FIG. 4, computing devices 62 such as, for example, personal computers, laptop computers, tablet PCs or any other such computing devices, may connect to a standalone OS loading system 20 via a network 60 such as, for example, Ethernet (broadband, high-speed), wireless WiFi, cable Internet, satellite connection, 3G, 4G, LTE or other cellular/mobile network, etc., or a combination thereof, in order to remotely load an OS. This may be used to select a desired OS from amongst multiple available OS and/or to allow two remote computing devices 62 to operate in a common state.

Referring to FIG. 5, there Is shown a flow diagram of the of the OS boot process 100. Steps of the process 100 are indicated by blocks 102 to 106.

The process 100 starts at block 102 where, upon boot-up, the image representation of the OS is acquired. This is accomplished by having the OS boot process 14a causing the CPU 12 to load the OS image 50 from the data storage 40.

Then, at block 104, the CPU 12 provides the OS Image 50 to the dedicated GPU 22 of the OS loading system 20 as art active image in its frame buffer 24;

Finally, at block 106, the operating system executable code encoded by the color values of the pixels 51 of the loaded OS image 50

Is accessed by the CPU 12 through the dedicated GPU 22. The OS code data encoded in each pixel can be individually addressed using the coordinates of the image pixels (i.e. XY coordinates for a 2D image or XYZ coordinates for a 3D image).

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope and spirit of the disclosure as hereinafter claimed.

What is claimed is:

1. A method for the loading of an operating system on a computing device having a central processing unit, the method comprising:
a) providing a dedicated operating system graphic processing unit in communication with the central processing unit;
b) acquiring an image representation of the operating system, the image being composed of pixels having color values encoding operating system executable code to be executed by the central processing unit;
c) providing the operating system image representation to the dedicated graphic processing unit;
d) accessing the encoded operating system executable code using the coordinates of the image pixels; and
e) providing the accessed encoded operating system executable code to the central processing unit;
wherein the central processing unit executes the provided accessed encoded operating system executable code.

2. A method for the loading of an operating system on a computing device according to claim 1, further comprising the step of providing image write functionality to the central processing unit to store data in an image representation of the data using the dedicated operating system graphic processing unit.

3. A method for the loading of an operating system on a computing device according to either of claim 1 or 2, further comprising the step of modifying the operating system image representation using the dedicated operating system graphic processing unit.

4. A method for the loading of an operating system on a computing device according to any of claims 1 to 3, wherein the image is either in 2D or 3D.

5. A method for the loading of an operating system on a computing device according to any of claims 1 to 4, wherein the dedicated operating system graphic processing unit is remotely located from the computing device.

6. A method for the loading of an operating system on a computing device according to any of claims 1 to 5, wherein the image representation of the operating system includes application data encoding application executable code to be executed by the central processing unit.

7. A method for the loading of an operating system on a computing device according to any of claims 1 to 6, wherein the operating system image representation Is composed of a plurality of images.

8. A system for the loading of an operating system on a computing device having a central processing unit having an associated memory, the system comprising:
a dedicated operating system graphic processing unit in communication with the central processing unit;
a data storage in communication with the central processing unit, the data storage having stored therein an image representation of the operating system, the image being composed of pixels having color values encoding operating system executable code to be executed by the central processing unit;
an operating system boot process stored in the associated memory, the operating system boot process being in the form of executable code to be executed by the central processing unit upon boot up and configuring the central processing unit to:
a) provide the operating system image representation stored in the data storage to the dedicated graphic processing unit;
b) access the encoded operating system executable code using the coordinates of the image pixels; and
c) execute the accessed encoded operating system executable code.

9. A system for the loading of an operating system on a computing device according to claim 8, wherein the central processing unit is further configured to store data in an image representation of the data using the dedicated operating system graphic processing unit.

10. A system for the loading of an operating system on a computing device according to either of claim 8 or 9, wherein the central processing unit is further configured to modify the operating system image representation.

11. A system for the loading of an operating system on a computing device according to any of claims 8 to 10, wherein the Image Is either in 2D or 3D.

12. A system for the loading of an operating system on a computing device according to any of claims 8 to 11, wherein the dedicated operating system graphic processing unit Is remotely located from the computing device.

13. A system for the loading of an operating system on a computing device according to any of claims 8 to 12, wherein the image representation of the operating system includes application data encoding application executable code to be executed by the central processing unit.

14. A system for the loading of an operating system on a computing device according to any of, claims 8 to 13, wherein the operating system image representation is composed of a plurality of images.
